(19) United States
(12) Patent Application Publication
(10) Pub. No.: US 2003/0123023 A1
(43) Pub. Date: Jul. 3, 2003

(54) Linking device for connecting secondary lens to spectacles

(76) Inventor: Hsien-Tsung Chang, Banchiao City (TW)

Correspondence Address: VENABLE, BAETJER, HOWARD AND CIVILETTI, LLP, P.O. BOX 34385, WASHINGTON, DC, 20043-9998, US

(21) Appl. No.: 10/298,673

(22) Filed: Nov. 19, 2002

(30) Foreign Application Priority Data
Nov. 20, 2001 (TW) 090219972

(51) Int. Cl. G02C 1/00; G02C 5/00

(52) U.S. Cl. 351/146

(57) ABSTRACT

A linking device for attaching secondary lenses to a pair of eyeglasses incorporates a magnetic component that allows the main body to be installed either on the end piece or on the bridge thereof, corresponding to the position of at least one magnetic holding pad on the secondary lenses; alternatively, the magnetic component can also be installed on two ends or in the middle section of the secondary lenses, corresponding to the position of at least one holding pad on the frame of eye glasses. Under such design, a pair of secondary lenses can be magnetically mounted onto the frame of a pair of regular eye glasses in front of the glass lenses as removable sunglasses.

### BACKGROUND OF THE INVENTION

1. Field of the Invention

The present invention relates to a linking device for connecting secondary lenses to regular eye glasses, in particular to a linking device that has a magnetic component to allow secondary lenses to be attached onto the frame of the regular eye glasses and positioned in front of the glass lens of the eye glasses.

2. Description of Related Arts

There is a type of removable sunglasses in fashion that allows color filtering lens to be attached onto the regular eye glasses without having to change glasses or to use any screws to hold them together. This new type of sunglasses incorporates a magnetic component either on the eye glasses or on the secondary lenses, which corresponds to the position of a magnetic holding pad on the counterpart, whereby a secondary lenses is attached onto the regular eye glasses as removable sunglasses by action of the magnetic component. When the ambient light gets too strong and causes irritation to the eyes, a person only has to take out a pair of secondary lenses and fit it onto the frame of the original eye glasses thus gaining the benefit of sunglasses. When the sunglasses are not needed, the person can remove the secondary lenses whilst still wearing the original eye glasses for reading or other normal functions making it unnecessary to change glasses.

This type of removable sunglasses employing magnetic force to connect the secondary lenses to the regular eye glasses has a magnetic component installed either on the bridge or on the two opposing end pieces of the eye glasses, which correspond to the position of a magnetic holding pad on the secondary lenses, such that the secondary lenses can be coupled with the frame of eye glasses as removable sunglasses. According to the conventional design, each pair of sunglasses has a magnetic holding pad created at a unique spot on the frame for coupling with the secondary lenses belonging to the same collection of lenses, which means the secondary lenses of different collections cannot be used interchangeably. A purchaser of the sunglasses has to buy the whole collection including the eye glasses and the whole series of lenses provided for changing the appearance of sunglasses. The purchaser of sunglasses cannot buy the secondary lenses alone, because it does not fit the original eye glasses. Thus, it is wasteful and uneconomic for a consumer to have to buy specific sets of sunglasses for each collection. Furthermore, the purchaser of the sunglasses also has to consider the adaptation period for each and every set of new lenses in the whole collection.

The present invention has made certain modification to the regular linking device to make the connection between the secondary lenses and the spectacle frame applicable across different sets of sunglasses.

### SUMMARY OF THE INVENTION

The main object of the present invention is to provide a new linking device for connecting secondary lenses to regular eye glasses. The device incorporates a magnetic component mounted at an appropriate location on the frame of regular eye glasses, corresponding to the position of a magnetic holding pad on the secondary lenses, whereby the secondary lenses can be mounted over the glass lenses of the eye glasses without using screws or other holding means, and the secondary lenses will be positioned in front of the glass lenses of the regular eye glasses as removable sunglasses. A purchaser of sunglasses, in accordance with the present invention, only needs to buy the secondary lenses and the linking device for fitting over the original eye glasses.

The second object of the present invention is to provide a linking device for connecting secondary lenses to regular eye glasses that incorporates a magnetic component mounted at an appropriate location on the secondary lenses, corresponding to the position of a magnetic holding pad on the eye glasses, whereby the secondary lenses can be mounted over the glass lenses of the eye glasses without using screws or other holding means, and the secondary lenses will be positioned in front of the glass lenses of the original eye glasses as removable sunglasses. A purchaser of sunglasses only needs to select a pair of eye glasses having a magnetic holding pad for coupling with the secondary lenses so that the secondary lenses can be fitted onto the eye glasses and worn as sunglasses.

The features and structure of the present invention will be more clearly understood when taken in conjunction with the accompanying drawings.

### BRIEF DESCRIPTION OF THE DRAWINGS

FIG. 1 is an exploded diagram showing the linking device used to connect the eye glasses and secondary lenses in accordance with the first embodiment of the invention;

FIG. 2 is a perspective view showing an assembly of the eye glasses and secondary lenses originally shown in FIG. 1;

FIG. 3 is a perspective view of the eye glasses and the linking device in accordance with the second embodiment of the invention;

FIG. 4 is a perspective view of the structure of the linking device in accordance with the third embodiment of the invention;

FIG. 5 is a cross-sectional view of the assembly of the linking device on the bridge of eye glasses originally shown in FIG. 4;

FIG. 6 is a perspective view of the structure of the linking device in accordance with the fourth embodiment of the invention;

FIG. 7 is a perspective view of the structure of the linking device in accordance with the fifth embodiment of the invention;

FIG. 8 is a perspective view of the structure and shape of the linking device in accordance with the sixth embodiment of the invention;

FIG. 9 is an exploded diagram showing the eye glasses and secondary lenses connected by the linking device in accordance with the sixth embodiment;

FIG. 10 is a front view of the assembly of the spectacle and secondary lenses as practiced by the sixth embodiment;

FIG. 11 shows the placement of the linking device on the upper and lower portions of the two end pieces of the eye glasses for connecting the secondary lenses of a different model, as practiced by the sixth embodiment of the invention;

FIG. 12 shows the placement of the linking device on the upper and lower portions of the two end pieces of the eye glasses for connecting secondary lenses of still another model, as practiced by the sixth embodiment of the invention;

FIG. 13 is an exploded diagram showing the linking device installed on the two end pieces of the eye glasses as practiced by the seventh embodiment of the invention; and

FIG. 14 is an exploded diagram showing the linking device installed on the two end pieces of the eye glasses as practiced by the eighth embodiment of the invention.

### DETAILED DESCRIPTION OF THE PREFERRED EMBODIMENT

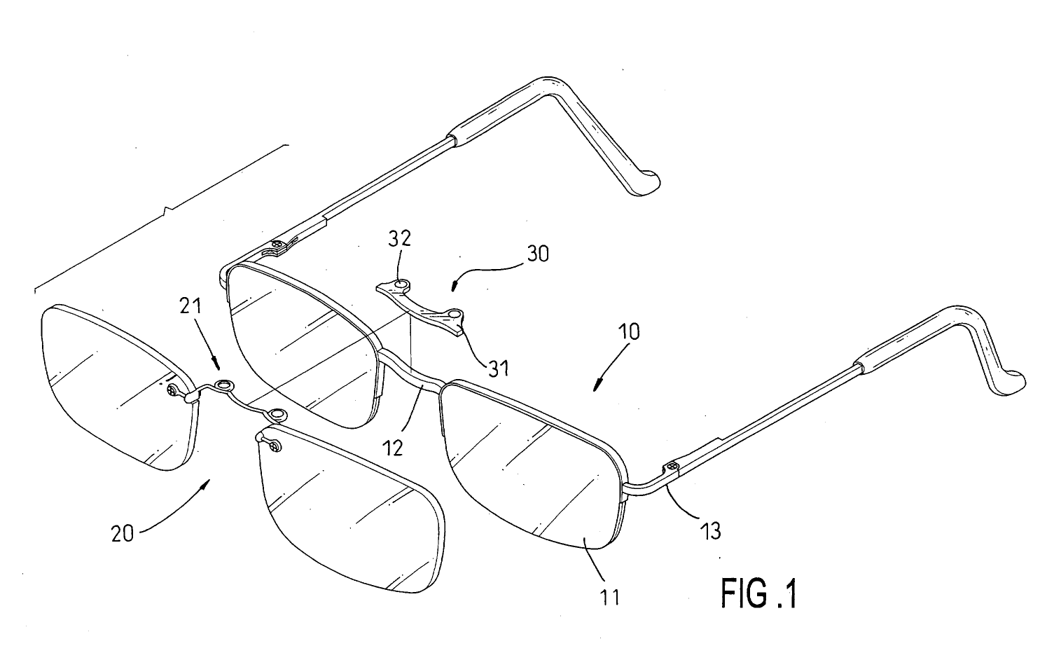

The present invention provides a linking device for connecting secondary lenses to a pair of regular eye glasses. FIG. 1 shows the structure of a regular eye glasses (10), in which a bridge (12) is used to join two adjacent glass lenses (11), enclosed by an extension bar (13) on the periphery of the two glass lenses (11), and two end pieces (not identified) are formed at the opposing ends of the extension bar (13). There are several types of eye glasses commonly worn by ordinary consumers, including eye glasses with rims, rimless glasses, and pinch nose type.

A pair of secondary lenses (20) as shown in FIG. 1 is mounted over the front of the glass lenses by means of a magnetic holding pad (21) having a permanent magnet embedded therein, and a linking device (30) has incorporated a magnetic component (32) in a main body (31), which could be a magnet or a magnetizable object. In the present invention, the linking device (30) for connecting secondary lenses (20) to regular eye glasses can be installed either on the bridge (12) or on opposing end pieces of regular eye glasses (10); alternatively the linking device (30) can also be installed on the secondary lenses (20) in like manner.

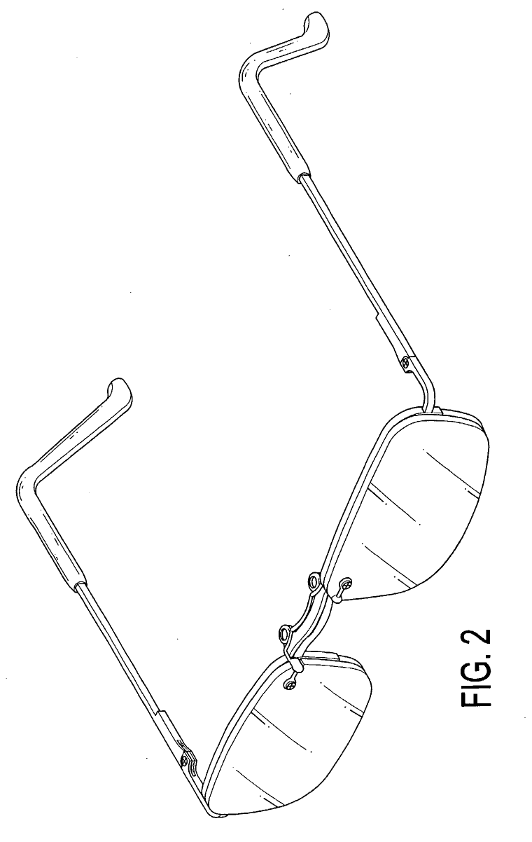

In FIGS. 1 and 2, the linking device (30) can be installed on the bridge (12) of the eye glasses (10) to correspond to the magnetic holding pad (21) embedded in the secondary lenses (20). The linking device (30) can be welded or glued onto the bridge (12), enabling the magnetic holding pad (21) of the secondary lenses (20) to be coupled with the magnetic component (32) on the linking device (30), such that the secondary lenses (20) can be connected to the eye glasses and positioned in front of the glass lenses (11) as removable sunglasses, without having to purchase the whole outfit, a series of lenses in the collection for a particular model of sunglasses, thus the product costs can be considerably reduced.

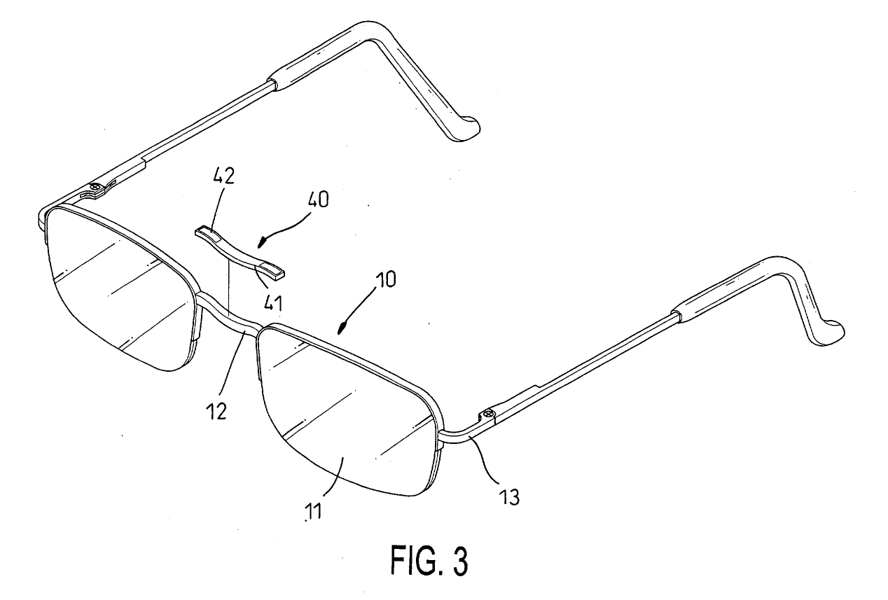

In FIG. 3 the linking device (40) has incorporated a magnetic component (42) in a main body (41) mounted on the bridge (12) of the regular eye glasses (10); alternatively, it can also be mounted on the secondary lenses (20) to work with corresponding eye glasses.

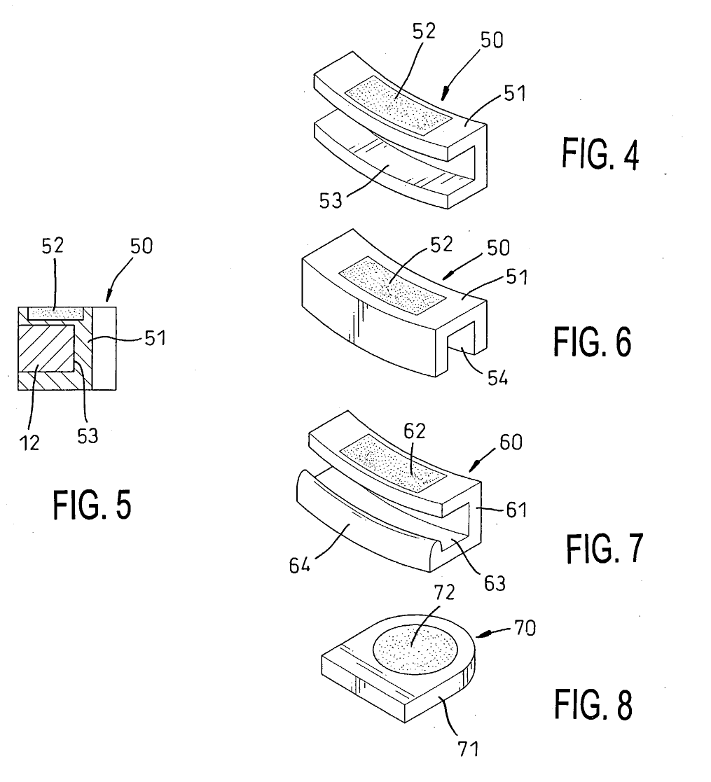

In FIGS. 4 and 5, the linking device (50) like the previously described embodiment also has incorporated a magnetic component (52) in the main body (51), but a clipping slot (53) is formed on one side of the main body (51), by which the secondary lenses (20) can be mounted on the bridge (12). Alternatively, the clipping slot (54) can also be formed in the lower part of the main body (61) as shown in FIG. 6; or the linking device (60) is also embedded with a magnetic component (62) on the main body (61) and a clipping slot (63) on one side of the main body (61), but there is a flange (64) at the end of the slot wall, as shown in FIG. 7.|

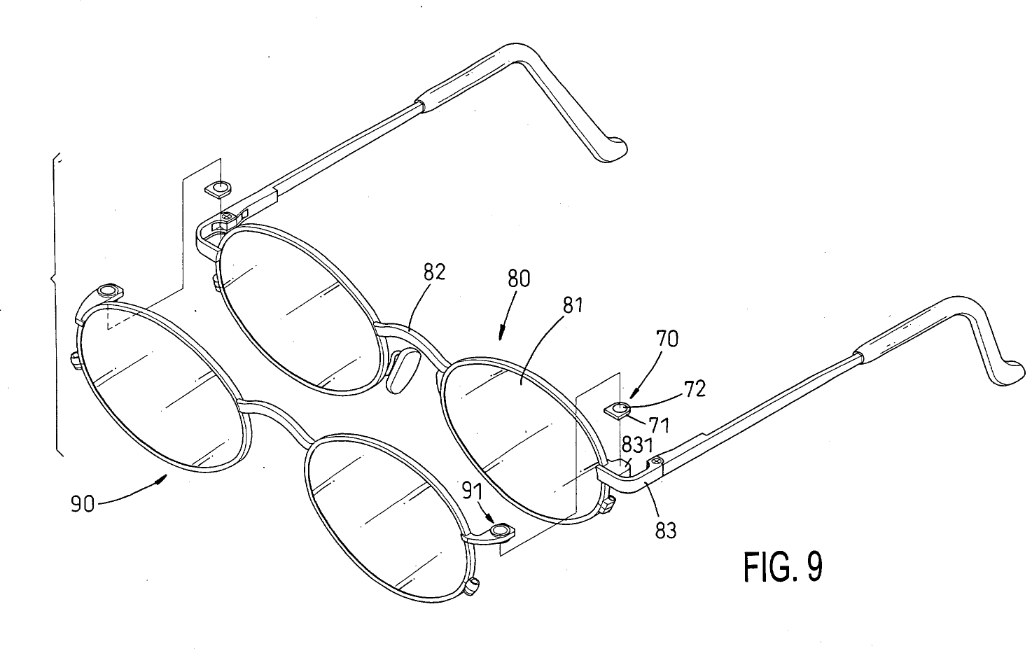

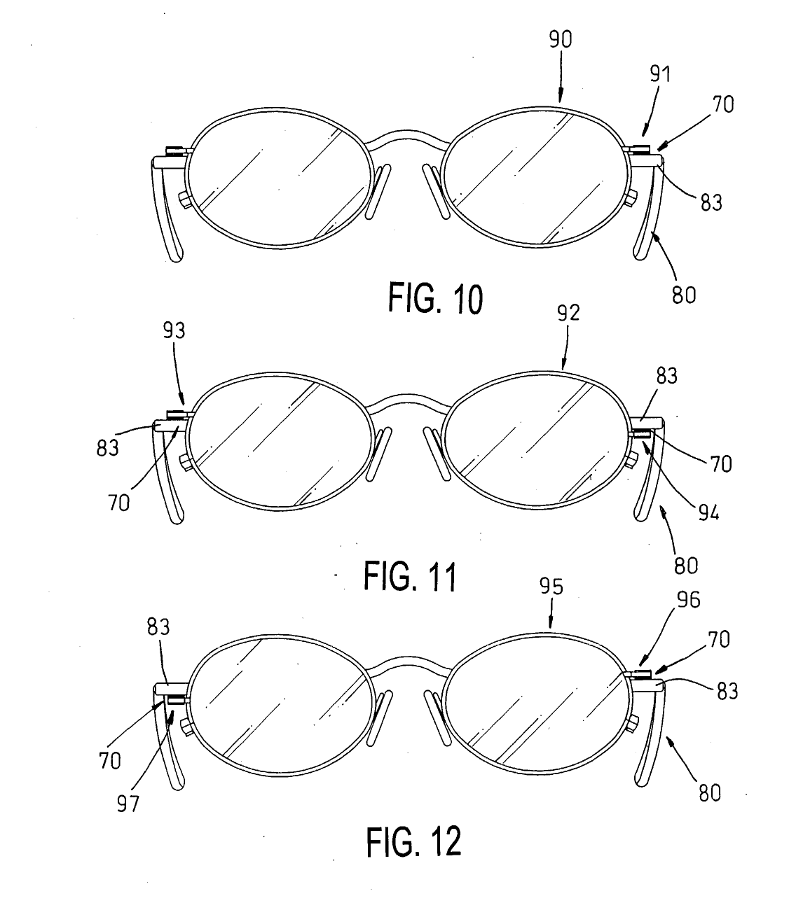

The above mentioned linking devices can all be installed on the bridge (12) or on the two end pieces (13) of the eye glasses (10) regardless of embodiments. the linking device (70), as shown in FIG. 9, is for installation on the two end pieces of the eye glasses (80), corresponding to the magnetic holding pad of the secondary lenses (90). In FIG. 9, the eye glasses (80) are formed by two glass lenses (81) connected by a bridge (82); an extension bar (83) encloses the two glass lenses (81); and on the opposing ends of the extension bar (83) are two end pieces (831). The secondary lenses (90) with an embedded magnetic holding pad (91) on two opposing ends is for placement over the corresponding magnetic component (72) of the linking device (70), such that the pair of secondary lenses (90) is positioned in front of the glass lenses (81) of the eye glasses (80) as shown in FIG. 10.

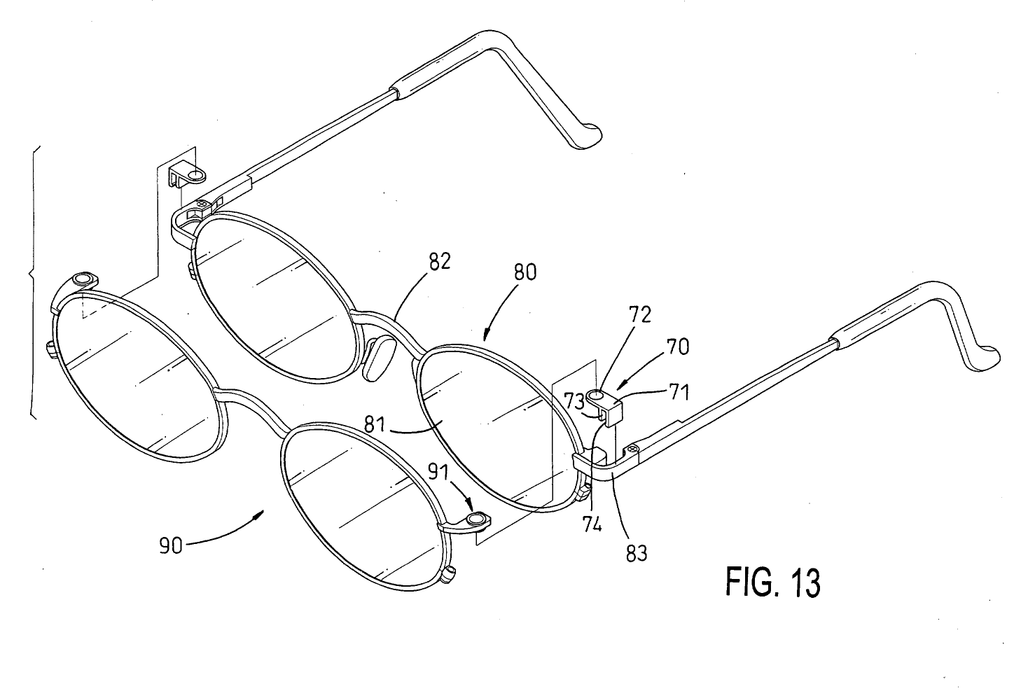

In FIGS. 11 and 12, one of the two magnetic components (77) is installed on the upper portion of one of the two end pieces (831) and the other magnetic component (77) is installed on the lower portion of the other end piece (831), and the corresponding upper and lower magnetic holding pads (93, 94) on the secondary lenses (92) are respectively coupled with the magnetic components (77) of the linking device (70). In FIG. 13, the linking device (70) has a magnetic component (72) embedded in the main body (71), and a clipping slot (73) with a flange (74) disposed at the lower end, which allows the linking device (70) to be clipped onto the extension bar (83) of the eye glasses (80), such that the secondary lenses (90) with magnetic holding pad (91) can be placed attached onto the linking device (70) and positioned in front of the glass lenses (81).

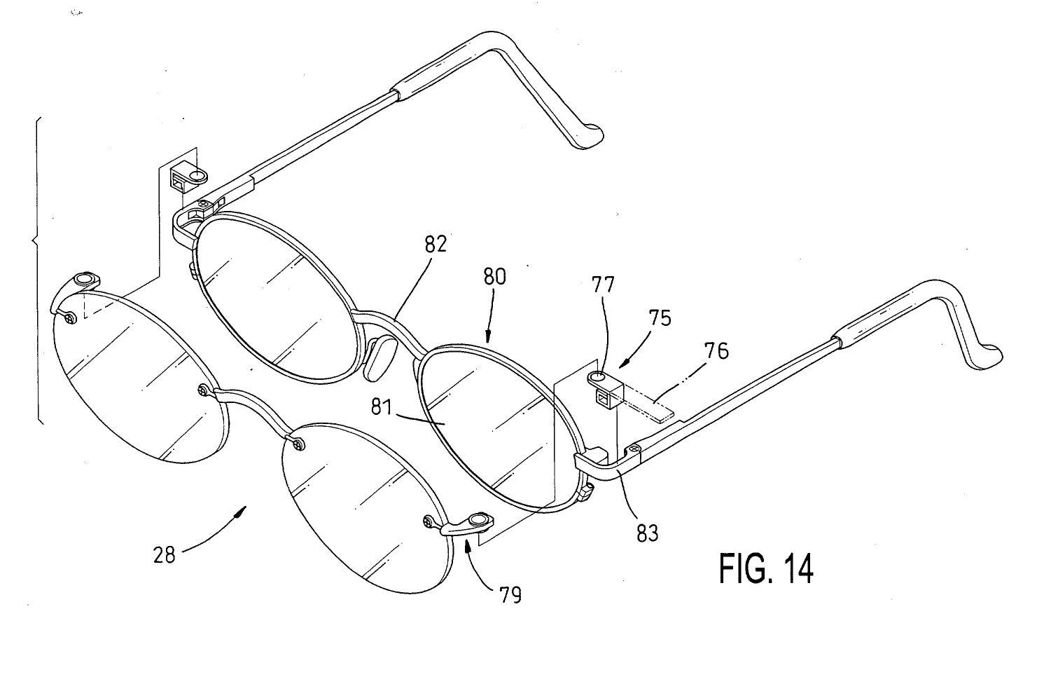

In FIG. 14, the main body (76) of the linking device (75) is formed from a malleable metal, one end of which has a magnetic component (77). By appropriate bending of the metal frame, the linking device can be installed on the bridge (82) or on two extension bars (83) of the eye glasses (80), such that the secondary lenses (90) can be mounted onto the eye glasses (80) through magnetic coupling at the bridge (82) or two extension bars (83) for positioning the secondary lenses (90) in front of the regular eye glasses (80). The main body (76) of the linking device (70) is coated with a layer of resin to enhance the mounting on the frame of the eye glasses (80) and to prevent physical damage to the surface coating on the eye glasses (80) causing ablation.

The linking device (75) as shown in FIG. 14 can be implemented with metal wire sheathed in the main body (76), one end of which has a magnetic component (77). By appropriate bending of the metal wire, the main body (76) of the linking device (75) can be placed over the corresponding magnetic holding pad (93, 94, and 96) of the secondary lenses (90) for positioning the secondary lenses over the glass lenses (81) of the eye glasses (80).

The secondary lenses (78) can be in the form of rimless lenses as shown in FIG. 14, wherein the magnetic holding pad (79) can be located on two ends or at the bridge portion, and the linking device (70) can be installed either on the extension bars (83) or the bridge (82) of the eye glasses (80) allowing the magnetic component (77) to be coupled with the magnetic holding pad of the secondary lenses (70).

For all types of secondary lenses mentioned above, the magnetic component has to be installed on the secondary lenses, and then the main body of the linking device has to be made from magnetic material, such as metal or other magnetizable object.

For eye glasses equipped with a magnetic holding pad, the linking device has to be installed at the location corresponding to the magnetic component on the secondary lenses, such that the secondary lenses can be precisely mounted over the rim of the eye glasses in front of the glass lenses.

If multiple secondary lenses are to be used interchangeably, the linking device has to be installed at a location corresponding to the magnetic holding pad of the secondary lenses, so that other secondary lenses can also be fitted over the same eye glasses.

Looking at the different shapes of the linking devices in various embodiment of the invention, it becomes clear that if the linking device is to be installed on a secondary lenses, one end of the main body can be fitted with a clipping slot to allow the secondary lenses to be mounted attached onto the end piece or bridge of the eye glasses. At the end of the slot wall there is a flange to allow the linking device to be fixed on the bridge of the secondary lenses, such that the secondary lenses can be adhered to the magnetic holding pad in the middle section of the eye glasses. Alternatively, the linking device can be installed on the opposing ends of the extension bar, such that the secondary lenses can be adhered to the magnetic holding pads on the upper and lower portions of the end pieces of the eye glasses.

The present invention enables a purchaser to convert regular eye glasses into sun glasses by using a magnetized component, such that the purchaser only has to purchase the secondary lenses for mounting over the regular eye glasses, so that regular eye glasses can be changed over to become optional sunglasses. The present invention is applicable to all models of secondary lenses to be fitted over a pair of regular eye glasses.

The foregoing description of the preferred embodiments of the present invention is intended to be illustrative only and, under no circumstances, should the scope of the present invention be so restricted.

What is claimed is:

1. A linking device for connecting secondary lenses to regular eye glasses includes a main body being installed on the regular eye glasses and having a magnetic component that corresponds to at least one magnetic holding region on the secondary lenses to allow the secondary lenses to be mounted over eye glasses.

2. The linking device as claimed in claim 1, wherein on one side of the main body of the linking device has a slot.

3. The linking device as claimed in claim 2, wherein a flange is formed at an end of the slot.

4. The linking device as claimed in claim 1, wherein the main body is made from a malleable metal and the magnetic component is installed on one end of the main body, such that by appropriate bending of the main body the linking device is precisely secured to the magnetic holding region on the secondary lenses.

5. The linking device as claimed in claim 4, wherein the main body is covered with a layer of resin to enhance the connection between the main body and the eye glasses, and further to prevent physical damage to the surface coating on a frame of the eye glasses causing ablation,

6. The linking device as claimed in claim 1, wherein a malleable metal wire is sheathed inside the main body that has the magnetic component installed on one end of the main body, such that by appropriate bending of the malleable metal wire the linking device is precisely secured to the magnetic holding region on the secondary lenses.

7. The linking device as claimed in claim 1, wherein the linking device is installed on a bridge portion of the eye glasses to correspond to the magnetic holding region in a middle section of the secondary lenses.

8. The linking device as claimed in claim 2, wherein the linking device is installed on a bridge portion of the eye glasses to correspond to the magnetic holding region in a middle section of the secondary lenses.

9. The linking device as claimed in claim 3, wherein the linking device is installed on a bridge portion of the eye glasses to correspond to the magnetic holding region in a middle section of the secondary lenses.

10. The linking device as claimed in claim 4, wherein the linking device is installed on a bridge portion of the eye glasses to correspond to the magnetic holding region in a middle section of the secondary lenses.

11. The linking device as claimed in claim 6, wherein the linking device is installed on a bridge portion of the eye glasses, to correspond to the magnetic holding region in a middle section of the secondary lenses.

12. The linking device as claimed in claim 1, wherein the linking device is secured to two extension bars of the regular eye glasses to correspond to the magnetic holding regions an two ends of the secondary lenses.

13. The linking device as claimed in claim 2, wherein the linking device is secured to two extension bars of the regular eye glasses to correspond to the magnetic holding regions on two ends of the secondary lenses.

14. The linking device as claimed in claim 3, wherein the linking device is secured to two extension bars of the regular eye glasses to correspond to the magnetic holding regions on two ends of the secondary lenses.

15. The linking device as claimed in claim 4, wherein the linking device is secured to two extension bars of the regular eye glasses to correspond to the magnetic holding regions on two ends of the secondary lenses.

16. The linking device as claimed in claim 6, wherein the linking device is secured to two extension bars of the regular eye glasses to correspond to the magnetic holding regions on two ends of the secondary lenses.

17. The linking device as claimed in claim 1, wherein the linking device is secured to upper and lower portions on two opposing extension bars of the eye glasses to correspond to the magnetic holding regions on upper and lower portions on two ends of the secondary lenses.

18. The linking device as claimed in claim 2, wherein the linking device is secured to upper and lower portions of two end pieces of the eye glasses to correspond to the magnetic holding regions an upper and lower portions on two ends of the secondary lenses

19. The linking device as claimed in claim 3, wherein the linking device is secured to upper and lower portions of two end pieces of the eye glasses to correspond to the magnetic holding regions on upper and lower portions on two ends of the secondary lenses.

20. The linking device as claimed in claim 4, wherein the linking device is secured to upper and lower portions of the two end pieces of the eye glasses to correspond to the magnetic holding regions on the upper and lower portions on two ends of the secondary lenses.

21. The linking device as claimed in claim 6, wherein the linking device is secured to the upper and lower portions of the two end pieces of the eye glasses to correspond to the magnetic holding regions on the upper and lower portions on two ends of the secondary lenses.

22. A linking device for connecting secondary lenses to regular eye glasses includes a main body being secured to the secondary lenses and having a magnetic component that corresponds to at least one magnetic holding region on the regular eye glasses to allow the secondary lenses to be mounted over the eye glasses.

23. The linking device as claimed in claim 22, wherein the main body has a slot on the lower portion.

24. The linking device as claimed in claim 23, wherein at the end of the slot wall on the main body is a flange for fixing the linking device at a specific location on the extension bar on the secondary lenses.

25. The linking device as claimed in claim 22, wherein the main body is made from malleable metal and the magnetic component is installed on one end of the main body, such that by appropriate bending of the metal frame the linking device is positioned at a location to allow the magnetic holding region on the secondary lenses to correspond to the magnetic component on the eye glasses.

26. The linking device as claimed in claim 25, wherein the main body is covered by a layer of resin to enhance the connection between the main body and the eye glasses and to prevent physical damage to the surface coating of a frame on the eye glasses causing ablation.

27. The linking device as claimed in claim 22, wherein a malleable metal wire is sheathed inside the main body with a magnetic component installed on one end, such that by appropriate bending of the metal wire the linking device is precisely positioned to allow the magnetic component on the secondary lenses to correspond to the magnetic holding region on the eye glasses.

28. The linking device as claimed in claim 22, wherein the linking device is secured to a bridge portion of the secondary lenses to allow the magnetic component thereon to correspond to the magnetic holding region in the middle section of the eye glasses.

29. The linking device as claimed in claim 23, wherein the linking device is secured to a bridge portion of the secondary lenses to allow the magnetic component thereon to correspond to the magnetic holding region in the middle section of the eye glasses.

30. The linking device as claimed in claim 24, wherein the linking device is secured to a bridge portion of the secondary lenses to show the magnetic component thereon to correspond to the magnetic holding region in the middle section of the eye glasses.

31. The linking device as claimed in claim 25, wherein the linking device is secured to a bridge portion of the secondary lenses to allow the magnetic component thereon to correspond to the magnetic holding region in the middle section of the eye glasses.

32. The linking device as claimed in claim 27, wherein the linking device is secured to a bridge portion of the secondary lenses to allow the magnetic component thereon to correspond to the magnetic holding region in the middle section of the eye glasses.

33. The linking device as claimed in claim 22, wherein the linking device is secured to two extension bars of the secondary lenses to correspond to the magnetic holding regions on two ends of the regular eye glasses.

34. The linking device as claimed in claim 23, wherein the linking device is secured to two extension bars of the secondary lenses to correspond to the magnetic holding regions on two ends of the regular eye glasses.

35. The linking device as claimed in claim 24, wherein the linking device is secured to two extension bars of the secondary lenses to correspond to the magnetic holding regions on two ends of the regular eye glasses.

36. The linking device as claimed in claim 25, wherein the linking device is secured to two extension bars of the secondary lenses to correspond to the magnetic holding regions on two ends of the regular eye glasses.

37. The linking device as claimed in claim 27, wherein the linking device is secured to two extension bars of the secondary lenses to correspond to the magnetic holding regions on two ends of the regular eye glasses,

38. The linking device as claimed in claim 22, wherein the linking device is secured to upper and lower portions an two ends of the extension bar on the secondary lenses to allow the magnetic holding regions thereon to correspond to the magnetic holding regions on the upper and lower portions on opposing ends of the eye glasses.

39. The linking device as claimed in claim 23, wherein the linking device is secured to the upper and lower portions on two ends of the extension bar on the secondary lenses to allow the magnetic holding regions thereon to correspond to the magnetic holding regions on the upper and lower portions on opposing ends of the eye glasses.

40. The linking device as claimed in claim 24, wherein the linking device is secured to the upper arid lower portions on two ends of the extension bar on the secondary lenses to allow the magnetic holding regions thereon to correspond to the magnetic holding regions on the upper and lower portions on opposing ends of the eye glasses.

41. The linking device as claimed in claim 25, wherein the linking device is secured to the upper and lower portions on two ends of the extension bar on the secondary lenses to allow the magnetic holding regions thereon to correspond to the magnetic holding regions on the upper and lower portions an opposing ends of the eye glasses.

42. The linking device as claimed in claim 27, wherein the linking device is secured to the upper and lower portions on two ends of the extension bar on the secondary lenses to allow the magnetic holding regions thereon to correspond to the magnetic holding regions an the upper and lower portions on opposing ends of the eye glasses.
